(19) United States
(12) Patent Application Publication
(10) Pub. No.: US 2026/0190192 A1
(43) Pub. Date: Jul. 2, 2026

(54) MULTIFUNCTIONAL NEW PHASE-CUT CONTROL CIRCUIT AND ITS IMPLEMENTATION METHOD

(71) Applicant: Zhuhai Demi Technology Co., Ltd., Zhuhai (CN)

(72) Inventors: Hongyu Cheng, Zhuhai (CN); Liutian Liang, Maoming (CN)

(21) Appl. No.: 19/551,958

(22) Filed: Feb. 27, 2026

(30) Foreign Application Priority Data
Feb. 8, 2026 (CN) 202610182644.X

(51) Int. Cl. H05B 45/14; H05B 45/31; H05B 45/325; H05B 45/34; H05B 45/345; H05B 45/59; H05B 47/25

(52) U.S. Cl. CPC H05B 45/14; H05B 45/31; H05B 45/325; H05B 45/34; H05B 45/345; H05B 45/59; H05B 47/25

(57) ABSTRACT

The present invention relates to the technical field of phase-cut control circuits, and specifically to a multifunctional new phase-cut control circuit and its implementation method. The multifunctional new type of phase-cut control circuit includes an input interface circuit, a signal detection circuit, a holding current control circuit, a current-limiting protection circuit and a control chip U1. Through multi-mode adaptive algorithms, intelligent detection and compensation, coordinated control and dynamic holding current adjustment, the present invention can maintain stable current compensation when controlling dimmers of different brands and models, improve dimming compatibility, ensure no flicker for low-power loads. Adapt to leading-edge phase-cutting and trailing-edge phase-cutting, and enhance dimming accuracy. Additionally, the circuit is simple and low in cost.

### TECHNICAL FIELD

The present invention relates to the technical field of phase-cut control circuits, in particular to a multifunctional novel phase-cut control circuit and its implementation method.

### BACKGROUND ART

Phase-cut dimming technology is widely used in the LED dimming field due to its advantages of low cost and simple circuit wiring. The existing phase-cut dimming power supply technology has the following deficiencies:
1.Unstable holding current control: Traditional phase-cut holding current circuits have problems such as high power consumption, severe heating and uncontrollable holding current, which easily lead to oscillation noise of the dimmer and fail to adapt to the requirements of different phase-cut controllers.
2. Poor dimming compatibility: Although the existing phase-cut dimming technology can adjust the dimming curve, it is not cooperatively controlled with the holding current circuit. As a result, the holding current is insufficient for some phase-cut controllers to work normally at the minimum/maximum conduction angle, leading to flicker and limited compatibility.
3. Flicker of low-power loads: Low-power LED lamps are prone to flicker during phase-cut dimming, and the existing technology has the problems of complex control, inflexibility and high cost.
4. Inability to identify leading-edge and trailing-edge phase-cut: The existing technology only converts the sine wave after phase-cut into a square wave through diodes and triodes for transmission to the subsequent stage, and cannot distinguish between leading-edge phase-cut and trailing-edge phase-cut. The freewheeling currents required for leading-edge phase-cut and trailing-edge phase-cut are different, and the maximum and minimum conduction angles of the two are inconsistent. The inability to identify them limits the compatibility of phase-cut dimming power supplies.
5. Poor dimming effect: Affected by power grid fluctuations, the phase-cut angle control is inaccurate. Restricted by the current provided by the freewheeling circuit, the phase-cut waveform becomes disordered when the phase-cut dimmer is in operation. The traditional zero-crossing detection circuit directly converts such disordered waveform into square waves and transmits them to the subsequent circuit, which results in poor dimming effect due to the disordered square waves.

Therefore, there is an urgent need to improve the phase-cut control circuit to solve the above problems.

### SUMMARY OF THE INVENTION

The objective of the present invention is to provide a multifunctional novel phase-cut control circuit and its implementation method. Through a multi-mode adaptive algorithm, intelligent detection and compensation, cooperative control and dynamic holding current adjustment, the invention can realize the control of dimmers of different brands and models, while achieving stable holding current compensation, improved dimming compatibility, no flicker for low-power loads, adaptive switching between leading-edge and trailing-edge phase-cut, and enhanced dimming precision, with the advantages of simple circuit structure and low cost.

To achieve the above objective, the main technical solutions adopted by the present invention include:
A multifunctional novel phase-cut control circuit, comprising an input interface circuit, a signal detection circuit, a holding current control circuit, a current-limiting protection circuit and a control chip U1;
The input interface circuit comprises a diode D1 and a diode D3, the anode of the diode D1 is electrically connected to an input terminal L, the anode of the diode D3 is electrically connected to an input terminal N, and the cathodes of the diode D1 and the diode D3 are commonly connected to a high-potential node inside the circuit;
The signal detection circuit comprises a resistor R1, a resistor R2, a capacitor C1, a resistor R5, a diode D2 and a zener diode Z1; one end of the resistor R1 is electrically connected to the high-potential node, and the other end is electrically connected to one end of the resistor R2; the other end of the resistor R2 is electrically connected to the anode of the diode D2, and the anode of the diode D2 is electrically connected to the cathode of the zener diode Z1, one end of the capacitor C1, pin 1 of the control chip U1 and one end of the resistor R5; the anode of the zener diode Z1, the other end of the resistor R5, the other end of the capacitor C1 and pin 2 of the control chip U1 are grounded;
The holding current control circuit comprises a triode Q1, a diode D4, a resistor R3, a resistor R4, a resistor R7 and a resistor R8; the collector of the triode Q1 is electrically connected to one end of the resistor R4; the other end of the resistor R4 is electrically connected to the output end of the signal input interface; the emitter of the triode Q1 is electrically connected to one end of the resistor R8 through the resistor R7; the other end of the resistor R8 is electrically connected to the ground; one end of the resistor R3 is electrically connected to pin 3 of the control chip U1, one end of a resistor R6 and a zener diode Z2; the other end of the resistor R3 is electrically connected to the output end of the signal input interface; the other pin of the zener diode Z2 is grounded; the other end of the resistor R6 is electrically connected to the anode of the diode D4 and the collector of a triode Q2; the cathode of the diode D4 is electrically connected to the base of the triode Q1; under the control of pin 3 of the control chip U1, current flows from the input interface circuit to the ground through the resistor R4, the triode Q1, the resistor R7 and the resistor R8, and the current flows through a phase-cut dimmer in an external main circuit to serve as holding current to prevent the phase-cut dimmer from false turn-off;
The current-limiting protection circuit comprises the triode Q2, the resistor R7 and the resistor R8; one end of the resistor R7 is electrically connected to the emitter of the triode Q1 and the base of the triode Q2, and the other end is electrically connected to one end of the resistor R8; the other end of the resistor R8 is grounded; when the current flowing through the resistor R7 and the resistor R8 exceeds a set threshold, a voltage drop generated at the common end of the resistor R7 and the resistor R8 triggers the triode Q2 to conduct; after the triode Q2 is conducted, the base voltage of the triode Q1 is pulled down to keep the flowing current at a set value, so as to realize current-limiting protection;
Pin 4 of the control chip U1 is electrically connected to a capacitor C2, and the other end of the capacitor C2 is grounded.

An implementation method of the multifunctional novel phase-cut control circuit, comprising the following steps:
1. Signal acquisition and processing: The phase-cut AC voltage output by the phase-cut dimmer is introduced through the diode D1 and the diode D3, and is applied to pin 1 of the control chip U1 after voltage division by the resistor R1, the resistor R2 and the resistor R5, wherein the capacitor C1 is used for filtering, the diode D2 is used for voltage clamping, and the zener diode Z1 is used for voltage stabilization; through voltage clamping by the diode D2, voltage stabilization by the zener diode Z1 and filtering by the capacitor C1, the final detection signal is input to pin 1 of the control chip U1; the control chip U1 realizes waveform restoration through algorithm data fusion according to the waveform characteristics of the signal, extracts waveform features through an algorithm, parses the conduction angle information and leading/trailing edge information of the current phase-cut dimmer, and generates control data of the holding current circuit for controlling the holding current circuit at the same time;
2. Dynamic adjustment of holding current: the control chip U1 controls the triode Q1 through pin 3 to automatically and dynamically adjust the magnitude of the holding current according to the parsed conduction angle information, holding current control data and leading/trailing edge information load state of the phase-cut dimmer, so as to ensure that the external phase-cut dimmer is free from false turn-off or poor conduction; the specific implementation is as follows: the control chip U1 outputs a high-level driving signal through pin 3, which is transmitted to the base of the triode Q1 through the resistor R6 and the diode D4 to conduct the triode Q1; after the triode Q1 is conducted, current flows from the phase-cut AC voltage output by the phase-cut dimmer to the ground through the diode D1, the diode D3, the resistor R4, the triode Q1, the resistor R7 and the resistor R8; the current flows through the phase-cut dimmer in the external main circuit to ensure that the total current is not lower than the holding current and prevent the dimmer from false turn-off; meanwhile, pin 6 of the control chip U1 outputs the phase-cut phase calculated by the algorithm, and the final phase output can select one of the following signals for output: a PWM signal, a serial port signal, or other digital coding signals such as Manchester coding;
3. Current-limiting protection action: When the triode Q1 is conducting, current flows through the detection resistor R7 and the detection resistor R8; during normal operation, the voltage drop across the resistor R7 and the resistor R8 is close to the conduction threshold of the triode Q2, and the currents in the triode Q2 and the triode Q1 are in a balanced state; if the current of the triode Q1 increases abnormally due to a circuit fault, the voltage drop across the resistor R7 and the resistor R8 exceeds the conduction threshold of the triode Q2; at this time, the triode Q2 is quickly conducted to pull the base potential of the triode Q1 down to the ground potential, force the triode Q1 to cut off, cut off the holding current loop, and protect circuit elements.

The present invention has at least the following beneficial effects:
Through the multi-mode adaptive algorithm, intelligent detection and compensation, cooperative control and dynamic holding current adjustment, the invention realizes the control of dimmers of different brands and models, and at the same time achieves stable holding current compensation, improved dimming compatibility, no flicker for low-power loads, adaptive switching between leading-edge and trailing-edge phase-cut, and enhanced dimming precision, with the advantages of simple circuit structure and low cost.

### BRIEF DESCRIPTION OF THE DRAWINGS

The drawings described herein are used to provide a further understanding of the present application and constitute a part of the present application. The illustrative embodiment of the present application and their descriptions are used to explain the present application and do not constitute an improper limitation of the present application. In the drawings:

FIG. 1 is the circuit diagram of the present invention;

FIG. 2 is the circuit structure diagram of the present invention.

### DETAILED DESCRIPTION OF THE EMBODIMENTS

The embodiments of the present application will be described in detail below in conjunction with the accompanying drawings and embodiments, so as to fully understand and implement the process of how the present application applies technical means to solve technical problems and achieve technical effects.

### Embodiment 1

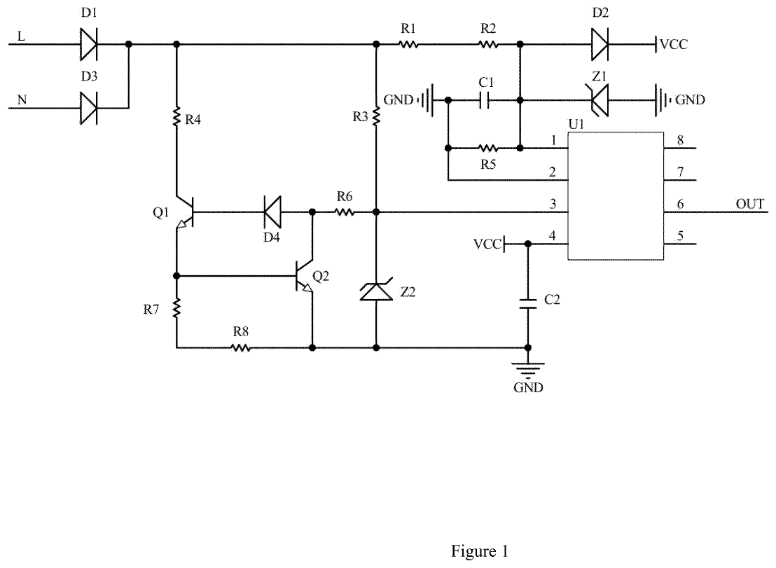

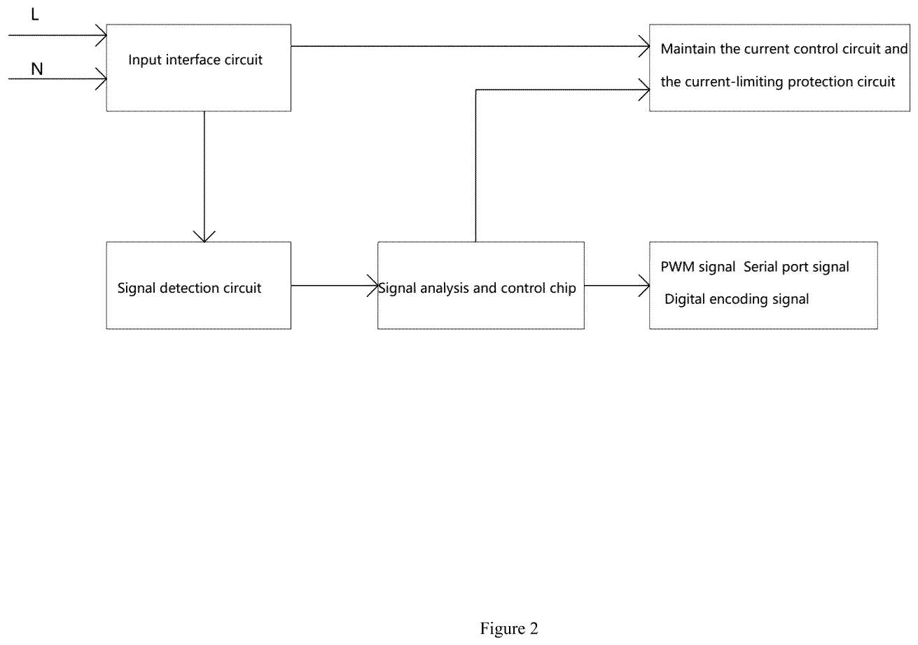

As shown in FIGS. 1-2, the multifunctional novel phase-cut control circuit provided in this embodiment has its input terminals L and N connected to the AC voltage after phase-cut by a phase-cut dimmer, and comprises an input interface circuit, a signal detection circuit, a holding current control circuit, a current-limiting protection circuit and a control chip U1;
The input interface circuit comprises a diode D1 and a diode D3, the anode of the diode D1 is electrically connected to the input terminal L, the anode of the diode D3 is electrically connected to the input terminal N, and the cathodes of the diode D1 and the diode D3 are commonly connected to a high-potential node inside the circuit; the input interface circuit is used to convert the phase-cut AC signal output by the phase-cut dimmer into a phase-cut pulsating wave and introduce it into the circuit, which serves as the input of the signal detection and holding current loop.

The signal detection circuit comprises a resistor R1, a resistor R2, a capacitor C1, a resistor R5, a diode D2 and a zener diode Z1; one end of the resistor R1 is electrically connected to the high-potential node (i.e., the cathode connection point of D1 and D3), and the other end is electrically connected to one end of the resistor R2; the other end of the resistor R2 is electrically connected to the anode of the diode D2, and the anode of the diode D2 is electrically connected to the cathode of the zener diode Z1, one end of the capacitor C1, pin 1 of the control chip U1 and one end of the resistor R5; the anode of the zener diode Z1, the other end of the resistor R5, the other end of the capacitor C1 and pin 2 of the control chip U1 are grounded (GND);
The function of this circuit is to collect the phase-cut pulsating wave signal output by the input interface circuit and input the signal to the control chip U1. The control chip U1 can sample data by one of the following methods: ADC, IO high and low level, internal comparator, analog watchdog. The control chip U1 realizes waveform restoration through algorithm data fusion, extracts waveform features through an algorithm, parses the conduction angle information (dimming brightness) and leading/trailing edge information of the current phase-cut dimmer, and generates control data of the holding current circuit for controlling the holding current circuit at the same time.

The holding current control circuit comprises a triode Q1, a diode D4, a resistor R3, a resistor R4, a resistor R7 and a resistor R8; the collector of the triode Q1 is electrically connected to one end of the resistor R4; the other end of the resistor R4 is electrically connected to the output end of the signal input interface (i.e., the cathode connection point of D1 and D3); the emitter of the triode Q1 is electrically connected to one end of the resistor R8 through the resistor R7; the other end of the resistor R8 is electrically connected to the ground (GND); one end of the resistor R3 is electrically connected to pin 3 of the control chip U1, one end of a resistor R6 and a zener diode Z2; the other end of the resistor R3 is electrically connected to the output end of the signal input interface (i.e., the cathode connection point of D1 and D3); the other pin of the zener diode Z2 is grounded (GND); the other end of the resistor R6 is electrically connected to the anode of the diode D4 and the collector of a triode Q2; the cathode of the diode D4 is electrically connected to the base of the triode Q1; under the control of pin 3 of the control chip U1, current flows from the input interface circuit to the ground through the resistor R4, the triode Q1, the resistor R7 and the resistor R8, and the current flows through the phase-cut dimmer in an external main circuit to serve as holding current to prevent the phase-cut dimmer from false turn-off;
The current-limiting protection circuit comprises the triode Q2, the resistor R7 and the resistor R8; one end of the resistor R7 is electrically connected to the emitter of the triode Q1 and the base of the triode Q2, and the other end is electrically connected to one end of the resistor R8; the other end of the resistor R8 is grounded (GND); when the current flowing through the resistor R7 and the resistor R8 exceeds a set threshold, a voltage drop generated at the common end of the resistor R7 and the resistor R8 triggers the triode Q2 to conduct; after the triode Q2 is conducted, the base voltage of the triode Q1 is pulled down to keep the flowing current at a set value, so as to realize current-limiting protection;
Pin 4 of the control chip U1 is electrically connected to a capacitor C2, and the other end of the capacitor C2 is grounded. The capacitor C2 serves as a power supply bypass filter capacitor for the control chip U1. The control chip U1 is used to receive the input of the signal detection circuit, output control signals to the holding current control circuit and output the phase-cut phase calculated by the algorithm. The final phase output can select one of the following signals for output: a PWM signal, a serial port signal, or other digital coding signals such as Manchester coding, which are output to pin 6 (OUT) of the control chip U1. The power supply of the control chip U1 is provided by an external circuit.

The working principle of the multifunctional novel phase-cut control circuit provided in this embodiment is as follows:
When an external phase-cut dimmer is connected, a phase-cut voltage appears at the input terminals L and N. Through the signal detection circuit composed of the diode D1, diode D3 and the subsequent resistor R1, resistor R2, diode D2, zener diode Z1, capacitor C1 and resistor R5, pin 1 of the control chip U1 parses the conduction angle information (dimming brightness) and leading/trailing edge information of the current phase-cut dimmer through algorithm operation according to the waveform characteristics of the signal, and calculates the control data of the holding current;
According to the calculated conduction angle information (dimming brightness), holding current control data and leading/trailing edge information of the phase-cut dimmer, the holding current control circuit is dynamically controlled on demand. The control chip U1 outputs a high-level driving signal through pin 3, which is transmitted to the base of the triode Q1 through the resistor R6 and the diode D4 to conduct the triode Q1. After the triode Q1 is conducted, current flows from the phase-cut AC voltage (L, N) output by the phase-cut dimmer to the ground (GND) through the diode D1, diode D3, resistor R4, triode Q1, resistor R7 and resistor R8. The current flows through the phase-cut dimmer in the external main circuit to ensure that the total current is not lower than the holding current and prevent the dimmer from false turn-off;
During normal operation, the voltage drop across the resistor R7 and the resistor R8 is close to the conduction threshold of the triode Q2, and the currents in the triode Q2 and the triode Q1 are in a balanced state, which keeps the current flowing through Q1 constant and effectively solves the compatibility and reliability problems in phase-cut dimming.

### Embodiment 2

This embodiment provides an implementation method of the multifunctional novel phase-cut control circuit according to Embodiment 1, comprising the following steps:
1. Signal acquisition and processing: The phase-cut AC voltage (L, N) output by the phase-cut dimmer is introduced through the diode D1 and the diode D3, and is applied to pin 1 of the control chip U1 after voltage division by the resistor R1, the resistor R2 and the resistor R5, wherein the capacitor C1 is used for filtering, the diode D2 is used for voltage clamping, and the zener diode Z1 is used for voltage stabilization; through voltage clamping by the diode D2, voltage stabilization by the zener diode Z1 and filtering by the capacitor C1, the final detection signal is input to pin 1 of the control chip U1; the control chip U1 realizes waveform restoration through algorithm data fusion according to the waveform characteristics of the signal, extracts waveform features through an algorithm, parses the conduction angle information (dimming brightness) and leading/trailing edge information of the current phase-cut dimmer, and generates control data of the holding current circuit for controlling the holding current circuit at the same time;
2. Dynamic adjustment of holding current: The control chip U1 controls the triode Q1 through pin 3 to automatically and dynamically adjust the magnitude of the holding current according to the parsed conduction angle information (dimming brightness), holding current control data and leading/trailing edge information load state of the phase-cut dimmer, so as to ensure that the external phase-cut dimmer is free from false turn-off or poor conduction; the specific implementation is as follows: the control chip U1 outputs a high-level driving signal through pin 3, which is transmitted to the base of the triode Q1 through the resistor R6 and the diode D4 to conduct the triode Q1; after the triode Q1 is conducted, current flows from the phase-cut AC voltage (L, N) output by the phase-cut dimmer to the ground through the diode D1, diode D3, resistor R4, triode Q1, resistor R7 and resistor R8; the current flows through the phase-cut dimmer in the external main circuit to ensure that the total current is not lower than the holding current and prevent the dimmer from false turn-off; meanwhile, pin 6 of the control chip U1 outputs the phase-cut phase calculated by the algorithm, and the final phase output can select one of the following signals for output: a PWM signal, a serial port signal, or other digital coding signals such as Manchester coding;
3. Over-current protection action: When the triode Q1 is conducting, current flows through the detection resistor R7 and the detection resistor R8; during normal operation, the voltage drop across the resistor R7 and the resistor R8 is close to the conduction threshold of the triode Q2, and the currents in the triode Q2 and the triode Q1 are in a balanced state; if the current of the triode Q1 increases abnormally due to a circuit fault, the voltage drop across the resistor R7 and the resistor R8 exceeds the conduction threshold of the triode Q2; at this time, the triode Q2 is quickly conducted to pull the base potential of the triode Q1 down to the ground potential, force the triode Q1 to cut off, cut off the holding current loop, and protect circuit elements.

The present invention has at least the following beneficial effects: Through the multi-mode adaptive algorithm, intelligent detection and compensation, cooperative control and dynamic holding current adjustment, the invention realizes the control of dimmers of different brands and models, and at the same time achieves stable holding current compensation, improved dimming compatibility, no flicker for low-power loads, adaptive switching between leading-edge and trailing-edge phase-cut, and enhanced dimming precision, with the advantages of simple circuit structure and low cost.

The above are only the preferred embodiments of the present invention and are not intended to limit the present invention in any form. Although the present invention has been disclosed above with the preferred embodiments, it is not intended to limit the present invention. Any person skilled in the art can make slight changes or modifications to equivalent embodiments with equivalent changes by using the technical contents disclosed above without departing from the scope of the technical solution of the present invention. However, any brief modification, equivalent change and modification made to the above embodiments according to the technical essence of the present invention without departing from the content of the technical solution of the present invention shall still fall within the scope of the technical solution of the present invention.

1. A multifunctional novel phase-cut control circuit, characterized by comprising an input interface circuit, a signal detection circuit, a holding current control circuit, a current-limiting protection circuit and a control chip U1;
The input interface circuit comprises a diode D1 and a diode D3, the anode of the diode D1 is electrically connected to an input terminal L, the anode of the diode D3 is electrically connected to an input terminal N, and the cathodes of the diode D1 and the diode D3 are commonly connected to a high-potential node inside the circuit;
The signal detection circuit comprises a resistor R1, a resistor R2, a capacitor C1, a resistor R5, a diode D2 and a zener diode Z1; one end of the resistor R1 is electrically connected to the high-potential node, and the other end is electrically connected to one end of the resistor R2; the other end of the resistor R2 is electrically connected to the anode of the diode D2, and the anode of the diode D2 is electrically connected to the cathode of the zener diode Z1, one end of the capacitor C1, pin 1 of the control chip U1 and one end of the resistor R5; the anode of the zener diode Z1, the other end of the resistor R5, the other end of the capacitor C1 and pin 2 of the control chip U1 are grounded;
The holding current control circuit comprises a triode Q1, a diode D4, a resistor R3, a resistor R4, a resistor R7 and a resistor R8; the collector of the triode Q1 is electrically connected to one end of the resistor R4; the other end of the resistor R4 is electrically connected to the output end of a signal input interface; the emitter of the triode Q1 is electrically connected to one end of the resistor R8 through the resistor R7; the other end of the resistor R8 is electrically connected to the ground; one end of the resistor R3 is electrically connected to pin 3 of the control chip U1, one end of a resistor R6 and a zener diode Z2; the other end of the resistor R3 is electrically connected to the output end of the signal input interface; the other pin of the zener diode Z2 is grounded; the other end of the resistor R6 is electrically connected to the anode of the diode D4 and the collector of a triode Q2; the cathode of the diode D4 is electrically connected to the base of the triode Q1; under the control of pin 3 of the control chip U1, current flows from the input interface circuit to the ground through the resistor R4, the triode Q1, the resistor R7 and the resistor R8, and the current flows through a phase-cut dimmer in an external main circuit to serve as holding current to prevent the phase-cut dimmer from false turn-off;
The current-limiting protection circuit comprises the triode Q2, the resistor R7 and the resistor R8; one end of the resistor R7 is electrically connected to the emitter of the triode Q1 and the base of the triode Q2, and the other end is electrically connected to one end of the resistor R8; the other end of the resistor R8 is grounded; when the current flowing through the resistor R7 and the resistor R8 exceeds a set threshold, a voltage drop generated at the common end of the resistor R7 and the resistor R8 triggers the triode Q2 to conduct; after the triode Q2 is conducted, the base voltage of the triode Q1 is pulled down to keep the flowing current at a set value, so as to realize current-limiting protection;
Pin 4 of the control chip U1 is electrically connected to a capacitor C2, and the other end of the capacitor C2 is grounded.

2. An implementation method of the multifunctional novel phase-cut control circuit according to claim 1, characterized by comprising the following steps:
Signal acquisition and processing: the phase-cut alternating current voltage output by the phase-cut dimmer is introduced through the diode D1 and the diode D3, and is applied to pin 1 of the control chip U1 after voltage division by the resistor R1, the resistor R2 and the resistor R5, wherein the capacitor C1 is used for filtering, the diode D2 is used for voltage clamping, and the zener diode Z1 is used for voltage stabilization; through voltage clamping by the diode D2, voltage stabilization by the zener diode Z1 and filtering by the capacitor C1, a final detection signal is input to pin 1 of the control chip U1; the control chip U1 realizes waveform restoration through algorithm data fusion according to the waveform characteristics of the signal, extracts waveform features through an algorithm, parses the conduction angle information and leading/trailing edge information of the current phase-cut dimmer, and generates control data of the holding current circuit at the same time for controlling the holding current circuit;
Dynamic adjustment of holding current: the control chip U1 controls the triode Q1 through pin 3 to automatically and dynamically adjust the magnitude of the holding current according to the parsed conduction angle information, holding current control data and leading/trailing edge information load state of the phase-cut dimmer, so as to ensure that the external phase-cut dimmer is free from false turn-off or poor conduction; the specific implementation is as follows: the control chip U1 outputs a high-level driving signal through pin 3, which is transmitted to the base of the triode Q1 through the resistor R6 and the diode D4 to conduct the triode Q1; after the triode Q1 is conducted, current flows from the phase-cut alternating current voltage output by the phase-cut dimmer to the ground through the diode D1, the diode D3, the resistor R4, the triode Q1, the resistor R7 and the resistor R8; the current flows through the phase-cut dimmer in the external main circuit to ensure that the total current is not lower than the holding current and prevent the dimmer from false turn-off; meanwhile, pin 6 of the control chip U1 outputs the phase-cut phase calculated by the algorithm, and the final phase output can select one of the following signals for output: a PWM signal, a serial port signal, or other digital coding signals such as Manchester coding;
Current-limiting protection action: when the triode Q1 is conducting, current flows through the detection resistor R7 and the detection resistor R8; during normal operation, the voltage drop across the resistor R7 and the resistor R8 is close to the conduction threshold of the triode Q2, and the currents in the triode Q2 and the triode Q1 are in a balanced state; if the current of the triode Q1 increases abnormally due to a circuit fault, the voltage drop across the resistor R7 and the resistor R8 exceeds the conduction threshold of the triode Q2; at this time, the triode Q2 is quickly conducted to pull the base potential of the triode Q1 down to the ground potential, force the triode Q1 to cut off, cut off the holding current loop, and protect circuit elements.
